(19) United States
(12) Patent Application Publication
(10) Pub. No.: US 2003/0137303 A1
(43) Pub. Date: Jul. 24, 2003

(54) Device for determining charge condition of electric storage battery connected to a consumer

(76) Inventor: Stefan Roepke, Leinfelden (DE)

Correspondence Address: STRIKER, STRIKER & STENBY, 103 East Neck Road, Huntington, NY, 11743, US

(21) Appl. No.: 10/335,729

(22) Filed: Jan. 2, 2003

(30) Foreign Application Priority Data
Jan. 24, 2002 (DE) 102 02 604.1

(51) Int. Cl. G01N 27/416

(52) U.S. Cl. 324/426

(57) ABSTRACT

A device for determining a charge condition of an electric storage battery connected to a consumer has a unit for detecting an operational value of the battery from which a charge condition can be derived, the unit being operative for detecting a terminal voltage of the battery and deriving the charge condition exclusively from such voltage values which are applied on output terminals of the battery when a level of current taken from the consumer reaches a predetermined value.

### BACKGROUND OF THE INVENTION

The present invention relates to a device for determining the charged condition of an electric storage battery connected to a consumer, for example of an electric power tool, in which means are available for detecting an operational value of the battery for deriving a charge condition therefrom.

For the operator of a battery-operated electrical device, for example of an electric hand power tool, it is very advantageous when he is provided with an information about the actual charge condition of the battery. As a result the operator knows whether and how long the electrical device with the coupled battery is operational. German patent document DE 41 06 725 A1 discloses a device for determining the charge condition of a battery, in which the charge condition is derived from the current which flows over the consumer. The current measurement and the determination of the charge condition from it requires relatively high expenses for a corresponding circuitry.

### SUMMARY OF THE INVENTION

Accordingly, it is an object of the present invention to provide a device of the above mentioned general type, which can determine the charge condition of an electric storage battery connected to a consumer with the lowest possible expenses for the circuitry.

In keeping with these objects and with others which will become apparent hereinafter, one feature of the present invention resides, briefly stated, in a device for determining the charge condition of electric storage battery connected to a consumer which has means for detecting an operational value of the battery from which a charge condition can be derived, said means being operative for detecting a terminal voltage of the battery and deriving the charge condition exclusively from such voltage values which are applied on output terminals of the battery when a level of current taken from the consumer reaches a predetermined value.

In the device in accordance with the present invention the terminal voltage of the battery is determined, and exclusively from these voltage values the charge condition is derived, which are then correspondingly applied on the output terminals of the battery when the level of the current taken by the consumer reaches a predetermined value. The terminal voltage, especially in lithium-ion batteries, is directly proportional to the charge condition. Therefore, no expensive circuitry features are required to derive from the terminal voltage the charge condition of the battery and finally provide an indication of the charge condition.

It is advantageous when in accordance with the present invention the fixed predetermined current level at which the terminal voltage is determined and then the charge condition is derived, has the value zero, or in other words the consumer is switched off.

It is advantageous when the consumer is provided with means such that, when the current has the predetermined level value, the means provided for determination of the charge condition signals that the instantaneously applied terminal voltage of the battery is to be detected. It is then especially advantageous that the means provided in the consumer recognizes the position of a switch with which the current supply to the consumer is turned on or turned off, and the means, when the consumer is turned off, signals to the means provided for determination of the charge condition that the instantaneously applied terminal voltage of the battery is detected.

Since the temperature of the battery has a certain influence on the charge condition, it is advantageous, in order to determine the charge condition error free to form a correction factor from the temperature for the charge condition derived from the measured terminal voltage.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a block diagram of an electric storage battery connected to a consumer, with a device for determining the charge condition of the battery, which is partially controlled from the consumer; and

FIG. 2 is a block diagram of an electric storage battery connected to a consumer and a device for determining the charge condition controlled from the battery.

### DESCRIPTION OF THE PREFERRED EMBODIMENTS

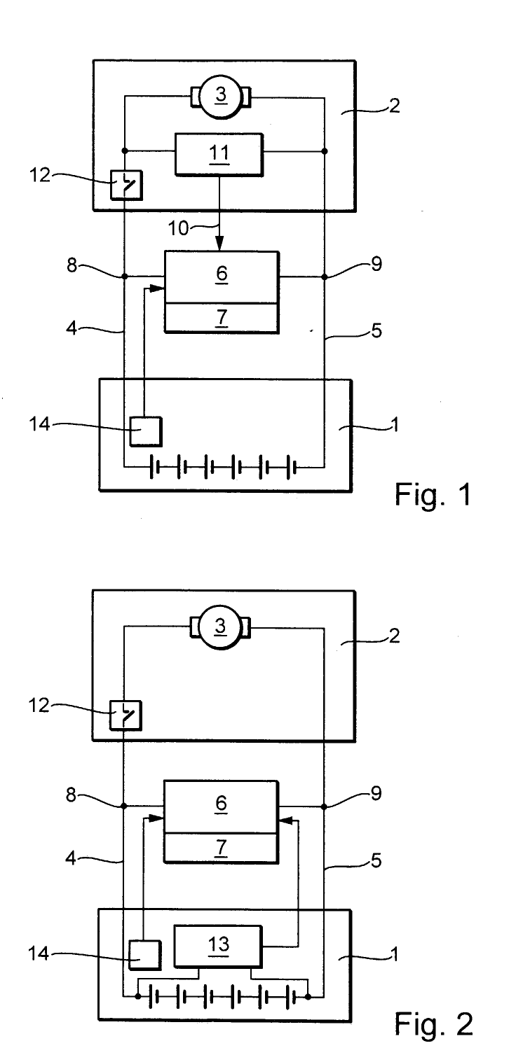

FIG. 1 shows a block diagram of an electric storage battery 1 and a consumer 2 which is connected to it. The consumer is conventionally an electrical device, for example an electric power tool, for example a screwdriver, a drill, a hammer drill, a saw, a grinder, etc. In the block 2 which symbolizes the consumer in FIG. 1 a drive motor 3 is shown. The drive motor is a motor which is conventionally utilized for example in electric power tools. The battery 1 can be composed of a single battery cell or of several battery cell which are connected with one another. The battery 1 is connected with the consumer 2 through current supply conductors 4 and 5.

The block diagram in FIG. 1 further has a device 6 for determining the charge condition of the battery 1. The device 6 can be integrated either in the device which represents the consumer 2 or in the battery 1, or it can be a self-contained component. An indicating unit 7 is electrically connected with the device 6. It indicates the charge condition which is determined by the device 6. Light diodes can be provided for representing several charge condition stages. The indicating unit 7 can be connected spatially with the device 6 or can be arranged also in the consumer 2, or can be formed as a spatially separated component.

The device 6 for determining the charge condition is in contact with both output terminals 8 and 9 of the battery 1. The device 6 taps the terminal voltage of the battery 1 on both output terminals 8 and 9. The terminal voltage, which is applicable in particular for lithium-ion batteries, is proportional to the actual charge condition of the battery 1.

Thereby the measured terminal voltage indicates the charge condition with the means having a simple circuitry.

In order to obtain an information about the charge condition of the battery 1 which is as unmistakable as possible, the charge condition is derived only from such terminal voltage values which are applied when a fixedly predetermined level of the current taken from the consumer 2 is provided. Therefore the device 6 for determining the charge condition requires an information as to when the current taken from the consumer 2 reaches the above identified fixedly predetermined level value. In the embodiment shown in FIG. 1, the device 6 obtains this information via a signal conductor 10 from the consumer 2. This information can be obtained preferably in the consumer 2 when it is provided with a control electronic system 11 which often is the case for example in electric power tools. The control electronic system 11 measures the current taken from the consumer 2.

The control electronic system performs in a known manner for example a torque or rotary speed control of the drive motor 3. With a simple threshold value separation, the electronic system 11 determines when the current taken from the consumer 2 reaches the fixedly predetermined level value. When the device 6 obtains the information through the signal conductor 10 from the control electronic system 11 of the consumer 2 that the predetermined current level is reached, the device 6 detects the terminal voltage of the battery 1 applied at this point of time. This terminal voltage is proportional to the actual charge condition of the battery and is indicated by the indicating unit 7.

It is advantageous to select the level zero as the fixedly predetermined level value for the current received from the consumer 2 with which the terminal voltage of the battery 1 must be detected as a value which represents its charge condition. The current taken from the consumer has then always the level zero when the consumer 2 is turned off from the battery 1. Each consumer has a switch 12, with which it can be turned on or turned off. The position of the switch 12 can be detected with the control electronic system 11 in the consumer 2. When the switch 12 is open, the control electronic system 11 sends through the signal conductor 10 an initialization signal to the device 6, which then detects the terminal voltage of the battery 1.

The initialization of the device 6 for the detection of the terminal voltage can be performed also from the battery 1, as shown in the embodiment of FIG. 2. Often a circuit 13 is provided in the battery housing, which monitors the charge or discharge of the battery 1 or controls it. The circuit 13 measures as a rule also the discharge current of the battery 1, or in other words the current which is taken from the consumer 2. In this case the circuit can monitor this current, as to whether it reaches a predetermined level. When the predetermined current level is reached, the circuit 13 always signals the device 6 for detection of the charge condition that the terminal voltage of the battery 1 is to be detected as a value which represents the charge condition.

In both embodiments shown in FIGS. 1 and 2 a temperature sensor 14 is provided in the battery 1. It transmits the temperature which instantaneously acts in the battery 1, to the device 6 for determining of the charge condition. Since the charge condition of a battery has a certain dependency from the temperature, it is recommended for the purpose of increasing the accuracy of the determined charge condition, to form from the temperature a correction value for the charge condition derived from the measured terminal voltage. With increasing temperature of the battery 1, true charge condition is greater than the one derived from the measured terminal voltage.

When in the description and in the claims the term “terminal voltage of the battery” is mentioned, this is applicable also to a terminal voltage of one or several individual battery cells, as well as to the battery which is composed of several battery cells connected with one another.

It will be understood that each of the elements described above, or two or more together, may also find a useful application in other types of constructions differing from the types described above.

While the invention has been illustrated and described as embodied in device for determining the charge condition of electric storage battery connected to a consumer, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for determining a charge condition of an electric storage battery connected to a consumer, comprising means for detecting an operational value of the battery from which a charge condition can be derived, said means being operative for detecting a terminal voltage of the battery and deriving the charge condition exclusively from such voltage values which are applied on output terminals of the battery when a level of current taken from the consumer reaches a predetermined value.

2. A device as defined in claim 1, wherein said means is formed so that said means derive the charge condition from such voltage values which are applied on the output terminals of the battery when a current has a level zero.

3. A device as defined in claim 1; and further comprising further means provided at the consumer and operative so that when the current reaches the predetermined value, said further means provide the signal to the means for determining the charge condition that an instantaneously applied terminal voltage of the battery is to be detected.

4. A device as defined in claim 3, wherein said further means is operative for detecting a position of a switch with which a current supply of the consumer is turned on or turned off, said further means, when the consumer is turned off, providing a signal to the means for determining the charge condition that an instantaneously applied terminal voltage of the battery is to be detected.

5. A device as defined in claim 1; and further comprising a temperature sensor for sensing a temperature of the battery, said means being operative for forming from the temperature sensed by said temperature sensor a correction value for the charge condition derived from the measured terminal voltage.
